(19) United States
(12) Patent Application Publication
(10) Pub. No.: US 2015/0093562 A1
(43) Pub. Date: Apr. 2, 2015

(54) Conductive Thermoplastic Resin Composition

(71) Applicant: Samsung SDI Co., Ltd., Yongin-si (KR)

(72) Inventors: Kyung Rae KIM, Uiwang-si (KR); Chan Gyun SHIN, Uiwang-si (KR); Jung Wook KIM, Uiwang-si (KR); Jong Cheol LIM, Uiwang-si (KR)

(21) Appl. No.: 14/503,558

(22) Filed: Oct. 1, 2014

(30) Foreign Application Priority Data
Oct. 1, 2013 (KR) 10-2013-0117146

(51) Int. Cl. C08K 9/02; C08K 7/14

(52) U.S. Cl. CPC C08K 9/02; C08K 7/14
USPC 428/300.1; 428/300.4

(57) ABSTRACT

A conductive thermoplastic resin composition includes polyethersulfone resin and a carbon nanotube (CNT)-oriented glass fiber. The conductive thermoplastic resin composition can have high electrical conductivity and remarkably improved mechanical physical properties with a small amount of CNTs.

### CROSS-REFERENCE TO RELATED APPLICATIONS

This application claims priority under 35 U.S.C. §119 to Korean Patent Application No. 10-2013-0117146, filed on Oct. 1, 2013, in the Korean Intellectual Property Office, the disclosure of which is incorporated herein by reference in its entirety.

### FIELD OF THE INVENTION

The following disclosure relates to a conductive thermoplastic resin composition.

### BACKGROUND

Thermoplastic resins have been widely used in various kinds of household goods, office automation equipment, electrical and electronic products, and the like, due to excellent workability and moldability. There have been attempts to impart specific properties to the thermoplastic resin, depending on the kind and property of the product in which the thermoplastic resin is used, to provide a high value-added material.

In recent years, there has been increasing demand for a functional resin having excellent properties such as mechanical strength, thermal resistance, chemical resistance, and the like, as a material for electrical and electronic, chemical, vehicle components, and the like. An example of one of these thermoplastic resins is a polyethersulfone resin having excellent thermal resistance, high-temperature rigidity, toughness and dimensional stability.

For example, there have been many attempts to provide electrical conductivity to the polyethersulfone resin to have an electromagnetic wave shield performance, and the like, depending on the kind and property of the product manufactured using the polyethersulfone resin. The resin can thereby be used in vehicles, various electrical devices, electronic assemblies, cables, and the like.

In general, in order to provide electrical conductivity to the polyethersulfone resin, conductive fillers such as carbon black, a carbon fiber, a carbon nanotube, a metal powder, a metal-coated inorganic powder, a metal fiber, and the like, may be mixed with the polyethersulfone resin.

However, since it is not easy to disperse the conductive fillers in the polyethersulfone resin which is a representative amorphous polymer, a large amount of the conductive fillers is required to implement a desired electrical conductivity. As a result, there are problems in that mechanical physical properties are deteriorated due to decrease in impact strength and elongation of an obtained molded article and a product may be damaged by generated particles and dust.

Korean Patent No. 1091866 discloses a conductive polyethersulfone resin composition having electrical conductivity by adding carbon nanotube and additives to a polyethersulfone resin. However, in order to implement a desired electrical conductivity, there is still a problem of requiring a high content of carbon nanotube. In addition, since the additives were used in order to disperse a large content of carbon nanotube, there were problems such as deterioration in mechanical physical properties of the resin, and the like.

### SUMMARY

An embodiment of the present invention is directed to providing a conductive thermoplastic resin composition that can have improved electrical conductivity and mechanical physical properties. In addition, another embodiment of the present invention is directed to providing a conductive thermoplastic resin composition that can have improved electrical conductivity using a small amount of carbon nanotube (CNT) by adding a carbon nanotube (CNT)-oriented glass fiber and a glass fiber to a polyethersulfone resin at an optimum ratio and an optimum content. Further, another embodiment of the present invention is directed to providing a conductive thermoplastic resin composition that can have remarkably improved mechanical physical properties and excellent workability.

In addition, another embodiment of the present invention is directed to providing a molded article manufactured by the conductive thermoplastic resin composition.

A conductive thermoplastic resin composition can include: a polyethersulfone resin, a carbon nanotube (CNT)-oriented glass fiber, and a glass fiber. The conductive thermoplastic resin composition can include about 70 to about 90 wt % of the polyethersulfone resin, about 1 to about 15 wt % of the carbon nanotube (CNT)-oriented glass fiber, and about 5 to about 25 wt % of the glass fiber.

The carbon nanotube (CNT)-oriented glass fiber may include carbon nanotube (CNT) on a surface thereof, the CNT being oriented so as to form a network structure, and may have an average diameter of about 10 to about 15 μm and an average length of about 3 to about 10 mm.

The conductive thermoplastic resin composition may include the carbon nanotubes (CNTs) in an amount of about 0.3 to about 2.0 wt % based on the total weight (100 wt %) of the conductive thermoplastic resin composition.

A weight ratio of the carbon nanotube (CNT)-oriented glass fiber and the glass fiber may be about 1:1 to about 1:5.

The polyethersulfone resin may have a weight average molecular weight of about 5,000 to about 150,000 g/mol.

There is also provided a molded article manufactured using the conductive thermoplastic resin composition as described above.

The molded article may have a surface resistance of about 10⁸ (Ω·cm) or less, the surface resistance measured by ASTM D257 standard, and a flexural modulus of about 55,000 to about 100,000 (kgf/cm), the flexural modulus measured by ASTM D790 standard.

The molded article may be used in a camera module of a mobile phone.

### DETAILED DESCRIPTION OF EMBODIMENTS

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Unless technical and scientific terms used herein are defined otherwise, they have meanings understood by those skilled in the art to which the present invention pertains.

Known functions and components which obscure the description and the accompanying drawings of the present invention with unnecessary detail will be omitted.

As a result of research for developing a thermoplastic resin composition having improved electrical conductivity, the present inventors found that a carbon nanotube (CNT)-oriented glass fiber and a glass fiber are contained in a polyethersulfone resin at an optimum ratio, such that dispersibility of CNT in the thermoplastic resin may be improved, electrical conductivity may be remarkably improved, and mechanical physical properties and workability may also be excellent, thereby completing the present invention.

Hereinafter, each component is described in more detail.

(A) Polyethersulfone Resin

A polyethersulfone resin according to an embodiment of the present invention, which is added for improvement of thermal resistance, dimensional stability, and chemical resistance, is a resin having sulfone bonds and an ether bonds in repeated frameworks.

The polyethersulfone resin of the present invention may contain a copolymer having at least one para-phenylene group positioned at any one site and at least one biphenyl group or phenyl ether group positioned at another site.

Examples of the polyethersulfone resin can include without limitation one or more compounds represented by the following Chemical Formulas 1 to 16:

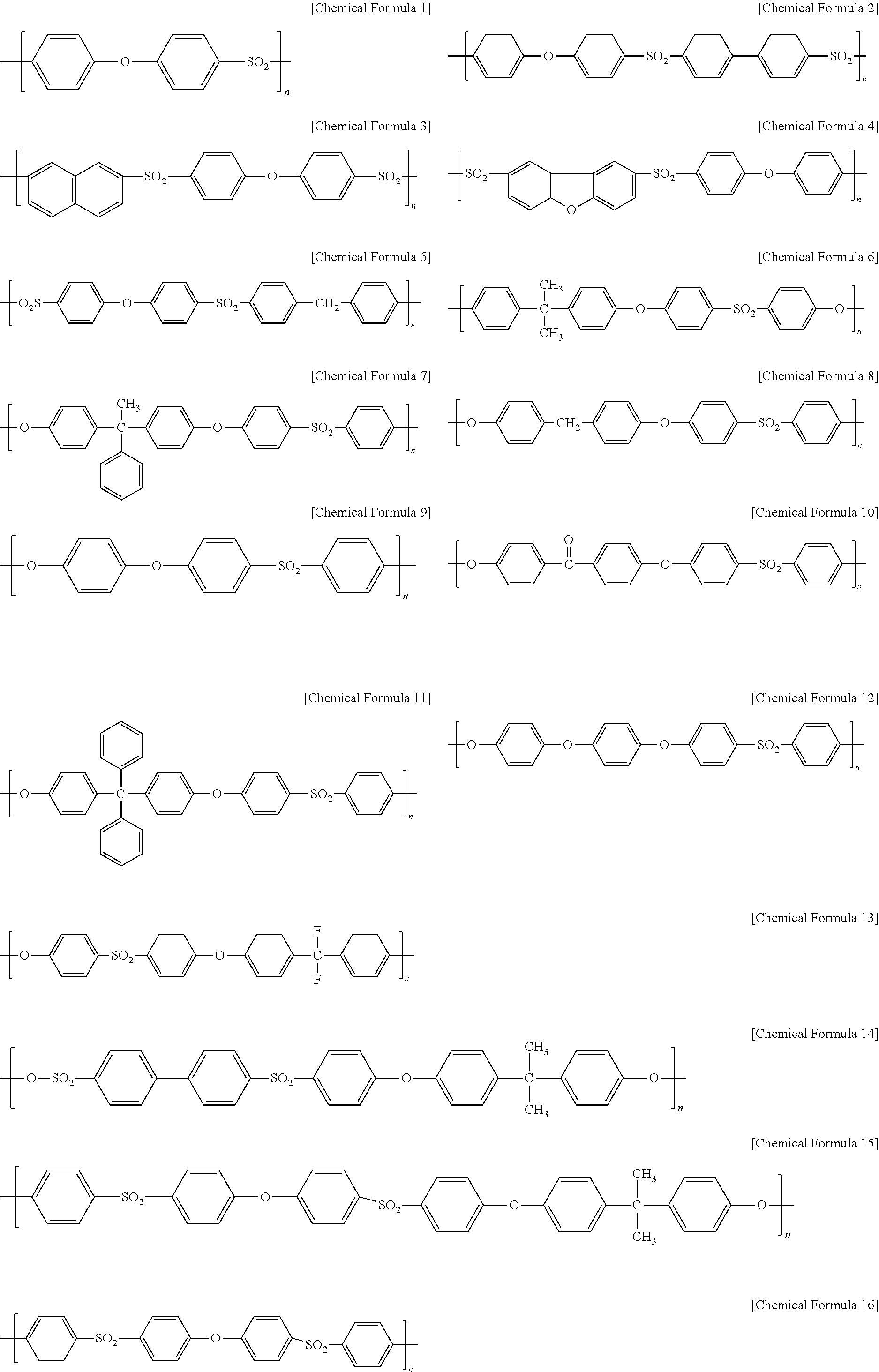

wherein, in Chemical Formulas 1 to 16, n is an integer of 10 or more, for example 10 to 500 and the phenyl group is capable of being substituted with one or more hydrogen and/or C1-C10 alkyl.

In exemplary embodiments, the compound represented by [Chemical Formula 1] may be used. The polyethersulfone resin used in the present invention may have a melting index of about 50 to about 100 g/10 mins, for example, about 60 to about 90 g/10 mins, the melting index measured under a load of 2.16 kg at 380° C.

In addition, the polyethersulfone resin can have a weight average molecular weight of about 5,000 to about 150,000 g/mol, for example about 6,000 to about 120,000 g/mol.

The polyethersulfone resin may be prepared by preparation methods known in the art, for example, may be prepared using 4,4′-dichlorodiphenylsulfone and 2,2′-bis(4-hydroxyphenyl)propane, but is not limited thereto.

The conductive thermoplastic resin composition of the invention may include the polyethersulfone resin in an amount of about 70 to about 90 wt %, for example about 75 to about 85 wt %, based on the total weight (100 wt %) of the conductive thermoplastic resin composition. Further, according to some embodiments of the present invention, the amount of the polyethersulfone resin can be in a range from about any of the foregoing amounts to about any other of the foregoing amounts.

When the amount of the polyethersulfone resin is less than about 70 wt %, thermal resistance may be decreased and thermal deformation may easily occur at a high temperature. In addition, when the amount of the polyethersulfone resin is more than about 90 wt %, the CNT-oriented glass fiber is present in a relatively decreased amount, such that electrical conductivity may be deteriorated.

(B) CNT-Oriented Glass Fiber

The CNT-oriented glass fiber according to an embodiment of the present invention may be added to the thermoplastic resin to provide electric conductivity. As the CNT-oriented glass fiber is dispersed in the thermoplastic resin, the CNT is also capable of being uniformly dispersed, such that high electrical conductivity may be implemented with a small content of CNT.

CNT-oriented glass fibers can be described as CNT-glass fiber composites, are known in the art and are commercially available. In the CNT-oriented glass fiber, a glass fiber may include carbon nanotubes (CNT) on a surface thereof, wherein the CNTs are oriented to form a network structure.

Any type of carbon nanotube (CNT) known in the art may be used without limitation. Examples the CNT may include without limitation double-walled carbon nanotubes, multi-walled carbon nanotubes, rope carbon nanotubes, and the like, and mixtures of two or more selected therefrom. In exemplary embodiments, a multi-walled carbon nanotube, which is typically relatively cheap and can have a high purity among the above-described CNTs, can be used.

The CNT-oriented glass fiber may have an average diameter of about 10 to about 15 μm and an average length of about 3 to about 10 mm. In this case, the CNT-oriented glass fiber can be easily dispersed in the conductive thermoplastic resin composition, and electrical conductivity may be remarkably improved with a small content of CNT. In addition, an improvement effect of mechanical physical properties may be shown by a combination with a glass fiber (a glass fiber that does not include oriented CNT).

The conductive thermoplastic resin composition may include the CNT-oriented glass fiber in an amount of about 1 to about 15 wt %, for example about 3 to about 12 wt %, based on the total weight (100 wt %) of the conductive thermoplastic resin composition. Further, according to some embodiments of the present invention, the amount of the CNT-oriented glass fiber can be in a range from about any of the foregoing amounts to about any other of the foregoing amounts.

When the amount of the CNT-oriented glass fiber is less than about 1 wt %, it may be difficult to implement a desired electrical conductivity. In addition, when the amount of the CNT-oriented glass fiber is more than about 15 wt %, fluidity may be deteriorated and thus, workability may be deteriorated.

(C) Glass Fiber

The glass fiber according to an embodiment of the present invention, which is different from the CNT-oriented glass fiber (B), is a glass fiber that does not include oriented CNT. The glass fiber, which is added for improvement of mechanical physical properties and dimensional stability, is not limited as long as it is a glass fiber known in the art.

As an example thereof, glass fibers having circular, oval, square and/or rectangular cross-sections may be used. In exemplary embodiments, a plate-shaped glass fiber having a rectangular cross-section can be used in order to improve appearance at the time of being injected as a molded article. For example, the glass fiber may have a plate-shaped structure in which a ratio between a major axis and a minor axis of the cross-section (referred to as an aspect ratio) is about 1.5 to about 8. When assuming that a long length (major axis) of the cross-section is a, and a short length (minor axis) thereof is b, the aspect ratio is defined as a/b, and when the aspect ratio satisfies the above-described range, mechanical physical properties such as flexural strength, and the like, may be improved.

The glass fiber may have an average diameter of about 5 to about 20 μm and an average length of about 0.2 to about 5 mm. In addition, the glass fiber may be non-treated or surface-modified, after being prepared. The surface-modification may be performed by general coating methods such as dip coating, spray coating, and the like. In addition, the surface-modification may be performed by a silane-coupling agent, but the present invention is not limited thereto.

The conductive thermoplastic resin composition may include the glass fiber in an amount of about 5 to about 25 wt %, for example about 8 to about 18 wt %, based on the total weight (100 wt %) of the conductive thermoplastic resin composition. Further, according to some embodiments of the present invention, the amount of the glass fiber can be in a range from about any of the foregoing amounts to about any other of the foregoing amounts.

When the amount of the glass fiber is less than about 5 wt %, improvement of thermal resistance and flexural strength may not be sufficient. In addition, when the amount of the glass fiber is more than about 25 wt %, fluidity may be deteriorated and workability and appearance may be poor, and the CNT-oriented glass fiber has a relatively decreased content, such that electrical conductivity may be deteriorated.

The CNT-oriented glass fiber (B) and the glass fiber (C) may be mixed at a weight ratio of about 1:1 to about 1:5, for example, a weight ratio of about 1:1 to about 1:3.

When the mixing ratio of the CNT-oriented glass fiber (B) is less than about 1, it may be difficult to implement a desired electrical conductivity. In addition, when the mixing ratio of the glass fiber (C) is less than about 1, it may be difficult to uniformly disperse the CNT-oriented glass fiber and the glass fiber. When the mixing ratio of the glass fiber (C) is more than about 5, the CNT-oriented glass fiber has a relatively decreased content, such that improvement of electrical conductivity may not be sufficient.

The conductive thermoplastic resin composition according to an embodiment of the present invention may include the carbon nanotube (CNT) in an amount of about 0.3 to about 2.0 wt %, based on the total weight (100 wt %) of the conductive thermoplastic resin composition. Further, according to some embodiments of the present invention, the amount of the CNT can be in a range from about any of the foregoing amounts to about any other of the foregoing amounts.

According to the related art, a desired electrical conductivity was capable of being achieved only when the CNT content satisfies 3 wt % or more of the total composition. However, according to the present invention, a desired electrical conductivity may be achieved even with a remarkably small content as compared to the related art.

In addition to the above-described components, the conductive thermoplastic resin composition of the present invention may further contain one or more various additives depending on a usage within the scope without hindering the objects of the present invention. Example of the additives may include without limitation antioxidants, mold release agents, flame retardants, lubricants, colorants, functional additives, thermoplastic elastomers, and the like, and mixtures thereof.

The conductive thermoplastic resin composition of the present invention may be prepared by methods known in the art. For example, the conductive thermoplastic resin composition may be prepared by mixing each component by Henschel mixer, V blender, a tumbler blender, a ribbon blender, and the like, followed by melt-kneading by a single screw extruder or a twin-screw extruder at a temperature of about 150 to about 300° C.

In addition, there is provided a molded article manufactured using the conductive thermoplastic resin composition as described above.

The molded article may have a surface resistance of about 10⁸ (Ω·cm) or less, the surface resistance measured by ASTM D257 standard, and a flexural modulus of about 55,000 to about 100,000 (kgf/cm²), the flexural modulus measured by ASTM D790 standard.

The above-described conductive thermoplastic resin composition may be molded as molded articles such as a camera module of a mobile phone, and the like, by known methods such as injection molding, extrusion molding, blow molding, and the like. In addition thereto, the conductive thermoplastic resin composition may be used in the manufacture of materials for precision components of personal home appliances and electronic products such as a note book, and the like, requiring electrical conductivity, mechanical physical properties, and dimensional stability.

Hereinafter, exemplary embodiments and methods of measuring physical properties will be described in detail. The exemplary embodiments are given by way of illustration only and are not intended to limit the protective scope defined by the attached claims.

Method of Measuring Physical Properties

(1) Flexural Strength and Flexural Modulus (kgf/cm²)

The measurement is conducted at a rate of 2.8 mm/min according to ASTM D790 standard.

(2) Surface Resistance (Q-cm)

The measurement is conducted according to ASTM D257 standard while using SRM-100 (Wolfgang Warmbier Ltd.).

### Example 1

As described in the following Table 1, a resin composition of Example 1 is prepared using about 80 wt % of a polyether sulfone resin (Veradel 3600 manufactured by Solvay Co.), about 10 wt % of a CNT-oriented glass fiber (CNT content: about 1.2 wt %, average diameter: about 13 LM, average length: about 10 mm), and about 10 wt % of a glass fiber (EC10 3MM 910 manufactured by Saint-Gobain Vetrotex).

The composition is processed at a nozzle temperature of about 250° C. by a twin-screw extruder satisfying 0=45 mm to be prepared as a pellet. Here, the CNT-oriented glass fiber and the glass fiber are injected into a side feeder. The prepared pellets are dried at about 100° C. for about 3 hours and then injection processed to form a sample. Physical properties of the sample are measured and the results are shown in the following Table 2.

### Example 2

As shown in the following Table 1, a resin composition sample of Example 2 is prepared by the same method as Example 1 above except for changing the amounts of the above-described components, and physical properties of the sample are measured and the results thereof are shown in the following Table 2.

### Comparative Examples 1 and 2

As shown in the following Table 1, resin composition samples of Comparative Examples 1 and 2 are prepared by the same method as Example 1 above except for using carbon nanotube (CNT) instead of than CNT-oriented glass fiber, and physical properties of each sample are measured and the results thereof are shown in the following Table 2.

### Comparative Examples 3 and 4

As shown in the following Table 1, resin composition samples of Comparative Examples 3 and 4 are prepared by the same method as Example 1 above except for changing the amounts of the above-described components, and physical properties of each sample are measured and the results thereof are shown in the following Table 2.

TABLE 1

| | | CNT- | | | CNT Content |
|---|---|---|---|---|---|
| | | oriented | Glass | | (wt %) in |
| | PES | Glass Fiber | Fiber | CNT | Total |
| | (wt %) | (wt %) | (wt %) | (wt %) | Composition |
| Example 1 | 80 | 10 | 10 | — | 1.2 |
| Example 2 | 80 | 5 | 15 | — | 0.6 |
| Comparative | 80 | — | 18.5 | 1.5 | 1.5 |
| Example 1 | | | | | |
| Comparative | 80 | — | 17 | 3.0 | 3.0 |
| Example 2 | | | | | |
| Comparative | 70 | 20 | 10 | — | 2.4 |
| Example 3 | | | | | |
| Comparative | 80 | 0.5 | 19.5 | — | 0.06 |
| Example 4 | | | | | |

TABLE 2

| | Surface | Flexural | Flexural |
|---|---|---|---|
| | Resistance | Strength | Modulus |
| | (Ω · cm) | (kgf/cm²) | (kgf/cm²) |
| Example 1 | 10⁴ | 1,060 | 55,800 |
| Example 2 | 10⁶ | 1,200 | 68,600 |
| Comparative | 10⁹ | 1,450 | 69,600 |
| Example 1 | | | |
| Comparative | 10⁶ | 920 | 67,300 |
| Example 2 | | | |
| Comparative | 10³ | 800 | 75,000 |
| Example 3 | | | |
| Comparative | 10¹² | 1,300 | 68,000 |
| Example 4 | | | |

As shown in the results from Comparative Examples 1 and 2, when directly adding CNT rather than using the CNT-oriented glass fiber, the CNT content in the resin composition is large, but an improvement in electrical conductivity is not sufficient.

As shown in the results from Comparative Examples 3 and 4, when the composition includes an excessive amount of the CNT-oriented glass fiber, electrical conductivity is improved; however, flexural strength is remarkably deteriorated, and when the composition includes a small content of the CNT-oriented glass fiber, surface resistance is high, such that an improvement effect of electrical conductivity is hardly shown.

Therefore, it can be appreciated that the conductive thermoplastic resin composition according to the present invention includes the carbon nanotube (CNT)-oriented glass fiber and the glass fiber added in a polyethersulfone resin at an optimum ratio, the CNT-oriented glass fiber may improve dispersibility in the thermoplastic resin even without using additional additives. Therefore, it may be appreciated that the conductive thermoplastic resin composition of the present invention can have excellent electrical conductivity even with a small content of CNT, thereby being appropriate for materials for precision components such as materials for cameral modules, and the like, of a mobile phone, a note book, and the like.

The conductive thermoplastic resin composition according to the present invention may include the CNT-oriented glass fiber to improve dispersibility in the thermoplastic resin even without using additional additives. Therefore, excellent electrical conductivity may be provided with a small amount of CNT. In addition, mechanical physical properties may be remarkably improved by adding the CNT-oriented glass fiber and the glass fiber (C) at an optimum ratio to the conductive thermoplastic resin composition.

Further, the conductive thermoplastic resin composition may have excellent workability, and at the time of being injected as a molded article, the molded article may have an aesthetic appearance, thereby being appropriate for materials for camera modules of electronic products such as a mobile phone, and the like.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A conductive thermoplastic resin composition comprising: a polyethersulfone resin (A), a carbon nanotube (CNT)-oriented glass fiber (B), and a glass fiber (C).

2. The conductive thermoplastic resin composition of claim 1, comprising about 70 to about 90 wt % of the polyethersulfone resin (A), about 1 to about 15 wt % of the carbon nanotube (CNT)-oriented glass fiber (B), and about 5 to about 25 wt % of the glass fiber (C).

3. The conductive thermoplastic resin composition of claim 1, wherein the carbon nanotube (CNT)-oriented glass fiber (B) includes carbon nanotubes (CNTs) on a surface thereof, the CNTs being oriented so as to form a network structure.

4. The conductive thermoplastic resin composition of claim 1, wherein the carbon nanotube (CNT)-oriented glass fiber (B) has an average diameter of about 10 to about 15 μm and an average length of about 3 to about 10 mm.

5. The conductive thermoplastic resin composition of claim 1, comprising the carbon nanotube (CNT) in an amount of about 0.3 to about 2.0 wt %.

6. The conductive thermoplastic resin composition of claim 1, comprising a weight ratio of the carbon nanotube (CNT)-oriented glass fiber (B) and the glass fiber (C) of about 1:1 to about 1:5.

7. The conductive thermoplastic resin composition of claim 1, wherein the polyethersulfone resin (A) has a weight average molecular weight of about 5,000 to about 150,000 g/mol.

8. A molded article manufactured by the conductive thermoplastic resin composition of claim 1.

9. The molded article of claim 8, having a surface resistance of about 10⁸ (Ω·cm) or less, the surface resistance measured by ASTM D257 standard.

10. The molded article of claim 8, having a flexural modulus of about 55,000 to about 100,000 (kgf/cm²), the flexural modulus measured by ASTM D790 standard.

11. The molded article of claim 8, wherein the article is a camera module of a mobile phone.
